(19) United States
(12) Patent Application Publication
(10) Pub. No.: US 2025/0272527 A1
(43) Pub. Date: Aug. 28, 2025

(54) IMAGE FORMING APPARATUS AND IMAGE QUALITY ADJUSTMENT METHOD CAPABLE OF SUPPRESSING EXPANSION AND CONTRACTION OF FORMED IMAGE IN SHEET CONVEYING DIRECTION WITHOUT CONSUMING INK

(71) Applicant: KYOCERA Document Solutions Inc., Osaka (JP)

(72) Inventor: Tatsuya Chuto, Osaka (JP)

(21) Appl. No.: 19/063,283

(22) Filed: Feb. 25, 2025

(30) Foreign Application Priority Data
Feb. 28, 2024 (JP) 2024-028356

(51) Int. Cl. G06K 15/02; B41J 11/00

(52) U.S. Cl. CPC G06K 15/1868; B41J 11/003; B41J 11/0095; G06K 15/1872; G06K 2215/101

(57) ABSTRACT

An image forming apparatus includes a first conveyance processing portion, a second conveyance processing portion, and an expansion/contraction processing portion. The first conveyance processing portion conveys a sheet. The second conveyance processing portion conveys the sheet after the conveyance of the sheet by the first conveyance processing portion. The expansion/contraction processing portion expands or contracts the size of an image to be formed by an ejection portion that ejects ink when it is determined that the same sheet as the sheet conveyed by the first conveyance processing portion has been conveyed by the second conveyance processing portion in an orientation different from that when the sheet was conveyed by the first conveyance processing portion.

### INCORPORATION BY REFERENCE

This application is based upon and claims the benefit of priority from the corresponding Japanese Patent Application No. 2024-028356 filed on Feb. 28, 2024, the entire contents of which are incorporated herein by reference.

### BACKGROUND

The present disclosure relates to an image forming apparatus and an image quality adjustment method.

In an inkjet image forming apparatus, ink is ejected from an ejection portion such as a line head onto a conveyed sheet, and an image is formed on the sheet. Also, a configuration is known in which an imaging portion for imaging a conveyed sheet is provided.

### SUMMARY

An image forming apparatus according to an aspect of the present disclosure includes a conveying belt, an ejection portion, an imaging portion, a first conveyance processing portion, a first acquisition processing portion, a second conveyance processing portion, a second acquisition processing portion, a determination processing portion, and an expansion/contraction processing portion. The conveying belt conveys a sheet along a predetermined conveying direction. The ejection portion ejects ink onto the sheet conveyed by the conveying belt. The imaging portion images the sheet conveyed by the conveying belt. The first conveyance processing portion conveys the sheet along a conveying path including a conveying section by the conveying belt. The first acquisition processing portion uses the imaging portion to acquire a size in the conveying direction of the sheet conveyed by the first conveyance processing portion and a size of the sheet in a width direction orthogonal to the conveying direction. The second conveyance processing portion conveys the sheet along the conveying path after the conveyance of the sheet by the first conveyance processing portion. The second acquisition processing portion uses the imaging portion to acquire a size in the conveying direction of the sheet conveyed by the second conveyance processing portion and a size in the width direction of the sheet. The determination processing portion determines, based on an acquisition result of the first acquisition processing portion and an acquisition result of the second acquisition processing portion, whether or not a same sheet as the sheet conveyed by the first conveyance processing portion has been conveyed by the second conveyance processing portion in an orientation different from that when the sheet was conveyed by the first conveyance processing portion. The expansion/contraction processing portion expands or contracts a size along the conveying direction of an image to be formed by the ejection portion based on the acquisition result of the first acquisition processing portion and the acquisition result of the second acquisition processing portion when it is determined that the same sheet as the sheet conveyed by the first conveyance processing portion has been conveyed by the second conveyance processing portion in the orientation different from that when the sheet was conveyed by the first conveyance processing portion.

An image quality adjustment method according to another aspect of the present disclosure is executed by an image forming apparatus including a conveying belt configured to convey a sheet along a predetermined conveying direction, an ejection portion configured to eject ink onto the sheet conveyed by the conveying belt, and an imaging portion configured to image the sheet conveyed by the conveying belt, and includes a first conveyance step, a first acquisition step, a second conveyance step, a second acquisition step, a determination step, and an expansion/contraction step. In the first conveyance step, the sheet is conveyed along a conveying path including a conveying section by the conveying belt. In the first acquisition step, the imaging portion is used to acquire a size in the conveying direction of the sheet conveyed by the first conveyance step and a size of the sheet in a width direction orthogonal to the conveying direction. In the second conveyance step, the sheet is conveyed along the conveying path after the conveyance of the sheet by the first conveyance step. In the second acquisition step, the imaging portion is used to acquire a size in the conveying direction of the sheet conveyed by the second conveyance step and a size in the width direction of the sheet. In the determination step, based on an acquisition result of the first acquisition step and an acquisition result of the second acquisition step, it is determined whether or not a same sheet as the sheet conveyed by the first conveyance step has been conveyed by the second conveyance step in an orientation different from that when the sheet was conveyed by the first conveyance step. In the expansion/contraction step, a size along the conveying direction of an image to be formed by the ejection portion is expanded or contracted based on the acquisition result of the first acquisition step and the acquisition result of the second acquisition step when it is determined that the same sheet as the sheet conveyed in the first conveyance step has been conveyed in the second conveyance step in the orientation different from that when the sheet was conveyed in the first conveyance step.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a cross-sectional view showing a configuration of an image forming apparatus according to an embodiment of the present disclosure.

FIG. 2 is a plan view showing a configuration of an image forming portion, a conveying unit, and a line sensor in the image forming apparatus according to the embodiment of the present disclosure.

FIG. 3 is a block diagram showing a system configuration of the image forming apparatus according to the embodiment of the present disclosure.

FIG. 4 is a flowchart showing an example of image quality adjustment processing executed in the image forming apparatus according to the embodiment of the present disclosure.

### DETAILED DESCRIPTION

An embodiment of the present disclosure will be described below with reference to the accompanying drawings. It is noted that the following embodiment is an example of embodying the present disclosure and does not limit the technical scope of the present disclosure.

### [Configuration of Image Forming Apparatus 100]

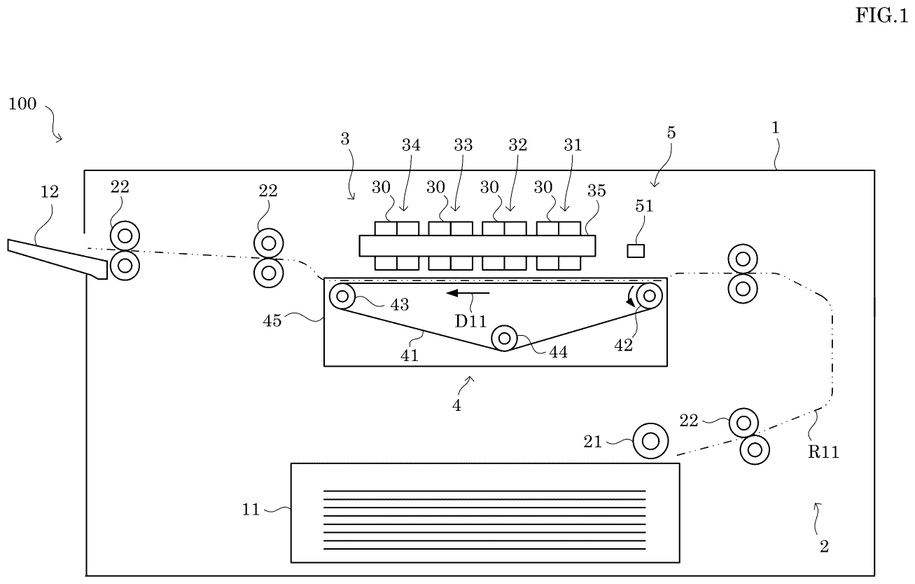

First, a configuration of an image forming apparatus 100 according to an embodiment of the present disclosure will be described with reference to FIG. 1 to FIG. 3. It is noted that a sheet conveying path R11 is indicated by a dash-dot-dot-dash line in FIG. 1.

The image forming apparatus 100 is a printer that can form an image on a sheet using an inkjet method. It is noted that the present disclosure may be applied to a facsimile machine, a copier, or a multifunction peripheral which can form an image on a sheet using an inkjet method.

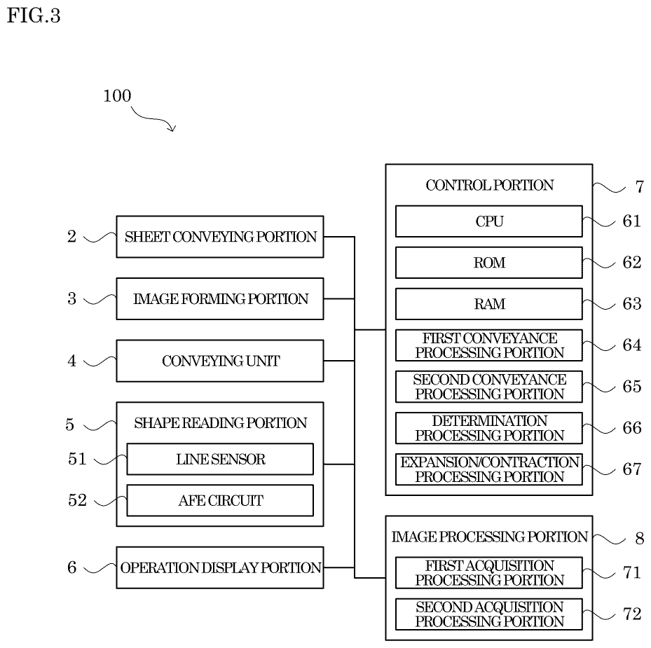

As shown in FIG. 1, the image forming apparatus 100 includes a housing 1, a sheet conveying portion 2, an image forming portion 3, a conveying unit 4, and a shape reading portion 5. In addition, the image forming apparatus 100 includes an operation display portion 6, a control portion 7, and an image processing portion 8 shown in FIG. 3.

The housing 1 houses the constituent elements of the image forming apparatus 100. In the housing 1, a sheet feed cassette 11 (see FIG. 1) is detachably provided. The sheet feed cassette 11 contains sheets on which images are formed. A sheet discharge tray 12 (see FIG. 1) is provided on an outer surface of the housing 1. Sheets on which images have been formed by the image forming portion 3 are discharged to the sheet discharge tray 12. Inside the housing 1, the sheets contained in the sheet feed cassette 11 are conveyed along the sheet conveying path R11 (see FIG. 1), which leads to the sheet discharge tray 12 via a position of image formation by the image forming portion 3.

The sheet conveying portion 2 conveys the sheets contained in the sheet feed cassette 11 along the sheet conveying path R11 (see FIG. 1). As shown in FIG. 1, the sheet conveying portion 2 includes a pickup roller 21 and a plurality of conveying rollers 22. The pickup roller 21 takes out the uppermost sheet of the sheet stack contained in the sheet feed cassette 11 and feeds the sheet to the sheet conveying path R11. The plurality of conveying rollers 22 are provided along the sheet conveying path R11. The conveying rollers 22 each convey the sheet along the sheet conveying path R11. The conveying rollers 22 each convey the sheet in a conveying direction D11 (see FIG. 1) from the sheet feed cassette 11 to the sheet discharge tray 12.

The image forming portion 3 forms an image on the sheet conveyed along the sheet conveying path R11 (see FIG. 1). As shown in FIG. 1, the image forming portion 3 includes line heads 31 to 34 and a head frame 35.

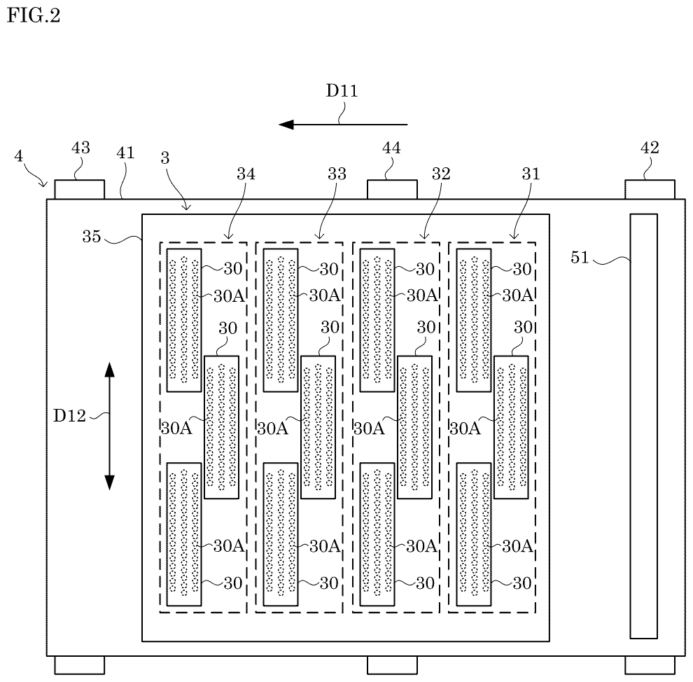

As shown in FIG. 2, each of the line heads 31 to 34 is long in a width direction D12 orthogonal to the conveying direction D11. Specifically, the line heads 31 to 34 each have a length in the width direction D12 corresponding to the width of the maximum size sheet among the sheets that can be contained in the sheet feed cassette 11. The line heads 31 to 34 are provided at regular intervals along the conveying direction D11.

As shown in FIG. 2, the line heads 31 to 34 each include a plurality of print heads 30. The print heads 30 each eject ink onto the sheet conveyed by a conveying belt 41 of the conveying unit 4. The print heads 30 provided in the line head 31 each eject black ink. The print heads 30 provided in the line head 32 each eject cyan ink. The print heads 30 provided in the line head 33 each eject magenta ink. The print heads 30 provided in the line head 34 each eject yellow ink. The lines heads 31 to 34 are examples of the ejection portion of the present disclosure.

The print heads 30 each include a plurality of nozzles 30A (see FIG. 2) that ejects ink. The plurality of nozzles 30A are provided on a surface of the corresponding print head 30 that faces the sheet conveyed by the conveying unit 4.

In addition, the print heads 30 each include a pressure chamber (not shown), a piezoelectric element (not shown), and an individual flow path (not shown) corresponding to each of the nozzles 30A. The pressure chamber communicates with the nozzle 30A and contains ink. The piezoelectric element causes the nozzle 30A to eject ink in response to application of a predetermined drive voltage. The individual flow path is an ink flow path provided between the pressure chamber and a common flow path (not shown) common to the plurality of nozzles 30A. A plurality of individual flow paths corresponding to the plurality of nozzles 30A are connected to the common flow path. The common flow path is connected to an ink supply portion (not shown) that supplies ink to each pressure chamber.

As shown in FIG. 2, the line head 31 includes three print heads 30 arranged in a staggered manner along the width direction D12. In addition, each of the other line heads 32 to 34 also has three print heads 30 arranged in a staggered manner along the width direction D12.

The head frame 35 supports the line heads 31 to 34. The head frame 35 is supported by the housing 1. It is noted that the number of line heads provided in the image forming portion 3 does not have to be four. In addition, the number of print heads 30 provided in each of the line heads 31 to 34 does not have to be three.

The image forming portion 3 forms, on the sheet, an image based on image data input from the image processing portion 8. Specifically, the image forming portion 3 controls ejection of ink by each of the line heads 31 to 34 based on the image data input from the image processing portion 8.

As shown in FIG. 1, the conveying unit 4 is disposed below the line heads 31 to 34. The conveying unit 4 conveys the sheet while having the sheet face the print heads 30. The line heads 31 to 34 each eject ink onto the sheet being conveyed by the conveying unit 4. As shown in FIG. 1, the conveying unit 4 includes a conveying belt 41 on which the sheet is placed, a first tension roller 42, a second tension roller 43, and a third tension roller 44 which tension the conveying belt 41, and a conveying frame 45 that supports them. It is noted that the gap between the conveying belt 41 and the print heads 30 is adjusted so that the gap between the surface of the sheet and the print heads 30 during image formation is a predetermined distance (for example, 1 mm).

The first tension roller 42 is driven to rotate by rotational drive force supplied by a motor (not shown). Thus, the conveying belt 41 rotates in a direction in which the sheet can be conveyed in the conveying direction D11 (see FIG. 1). The conveying belt 41 conveys the sheet placed on its outer peripheral surface along the conveying direction D11. It is noted that the conveying unit 4 is also provided with a suction unit (not shown) that sucks air through a large number of through holes formed in the conveying belt 41 in order to attract the sheet to the conveying belt 41.

The shape reading portion 5 reads the shape of the sheet conveyed along the sheet conveying path R11.

As shown in FIG. 3, the shape reading portion 5 includes a line sensor 51 and an analog front-end (AFE) circuit 52.

As shown in FIG. 1, the line sensor 51 is provided upstream of the image forming portion 3 in the conveying direction D11 on the sheet conveying path R11. In addition, the line sensor 51 is provided above the conveying belt 41. In addition, as shown in FIG. 2, the line sensor 51 is long along the width direction D12. The line sensor 51 captures an image of the sheet conveyed by the conveying belt 41. The line sensor 51 is an example of the imaging portion of the present disclosure.

For example, the line sensor 51 is a contact image sensor (CIS). The line sensor 51 includes a plurality of imaging elements arranged in the width direction D12 (see FIG. 2). Each of the imaging elements includes a light emitting portion and a light receiving portion. The light emitting portion emits light toward the conveying belt 41. The light receiving portion is provided so as to be able to receive light emitted from the light emitting portion and reflected by the conveying belt 41 or the sheet being conveyed, and outputs an analog electric signal corresponding to the amount of received light. The line sensor 51 captures an image of the sheet conveyed along the sheet conveying path R11 at a predetermined imaging cycle. Specifically, the line sensor 51 outputs, at the imaging cycle, an analog electric signal corresponding to an image of an imaging target (the sheet and the conveying belt 41) that faces the line sensor 51. It is noted that the outer peripheral surface of the conveying belt 41 is colored a color, such as black, that suppresses the reflection of light emitted from the light emitting portion more than the base color (white) of the sheet.

The AFE circuit 52 is an electronic circuit that executes a predetermined process on the analog electric signal output from the line sensor 51. Specifically, the AFE circuit 52 includes a signal conversion portion that converts the analog electric signal output from the line sensor 51 into a digital electric signal (image data). In addition, the AFE circuit 52 includes a binarization portion that executes a binarization process on the image data output from the signal conversion portion. In the binarization process, each pixel included in the image data output from the signal conversion portion is binarized into a value indicating the presence or absence of a sheet. The image data binarized by the binarization portion (hereinafter referred to as “line data”) is input to the image processing portion 8.

The shape reading portion 5 outputs shape data indicating the shape of the sheet whose image is captured by the line sensor 51. The shape data is data composed of a plurality of the line data output from the AFE circuit 52 during a period in which the shape of the sheet is read by the shape reading portion 5.

The operation display portion 6 is a user interface of the image forming apparatus 100. The operation display portion 6 includes a display portion and an operation portion. The display portion displays various types of information in response to control instructions from the control portion 7. For example, the display portion is a flat panel display such as a liquid crystal display. The operation portion inputs various types of information to the control portion 7 in response to user operations. For example, the operation portion includes an operation key and a touch panel.

The control portion 7 performs overall control of the image forming apparatus 100. As shown in FIG. 3, the control portion 7 includes a CPU 61, a ROM 62, and a RAM 63. The CPU 61 is a processor that executes various types of arithmetic processing. The ROM 62 is a nonvolatile storage device in which information such as control programs for causing the CPU 61 to execute various types of processing are stored in advance. The RAM 63 is a volatile or nonvolatile storage device used as a temporary storage memory (work area) for various types of processing executed by the CPU 61. The CPU 61 performs overall control of the image forming apparatus 100 by executing various control programs stored in the ROM 62 in advance.

The image processing portion 8 adjusts the image data input to the image forming portion 3, that is, the image data used for image formation on the sheet, based on the shape data input from the shape reading portion 5. For example, based on the shape data input from the shape reading portion 5, the image processing portion 8 masks a portion of the image data input to the image forming portion 3 which is used for image formation on the outside of the sheet conveyed along the sheet conveying path R11. As a result, ejection of ink to the outside of the sheet is suppressed. The image processing portion 8 is constituted by an electronic circuit such as an integrated circuit (ASIC, DSP).

By the way, in the image forming apparatus 100, an image formed by the line heads 31 to 34 may be expanded or contracted in the conveying direction D11 more than an original image such as a document sheet image. On the other hand, a configuration is conceivable in which a predetermined detection image is formed on a sheet using the line heads 31 to 34, the size in the conveying direction D11 of the detection image formed on the sheet is measured using the line sensor 51, and the ink ejection cycle by the line heads 31 to 34 is adjusted based on the measurement result. However, in this configuration, ink is consumed during the adjustment of the ejection cycle.

On the other hand, in the image forming apparatus 100 according to the embodiment of the present disclosure, as will be described below, it is possible to suppress expansion or contraction in the conveying direction D11 of the formed image without consuming ink.

As shown in FIG. 3, the control portion 7 includes a first conveyance processing portion 64, a second conveyance processing portion 65, a determination processing portion 66, and an expansion/contraction processing portion 67. By executing the control programs stored in the ROM 62, the CPU 61 of the control portion 7 functions as the respective portions described above. It is noted that the processing portions described above may be implemented by an electronic circuit.

In addition, as shown in FIG. 3, the image processing portion 8 includes a first acquisition processing portion 71 and a second acquisition processing portion 72. It is noted that, by executing the control programs stored in the ROM 62, the CPU 61 of the control portion 7 may function as the respective portions described above.

The first conveyance processing portion 64 executes a first conveyance process of conveying the sheet along a sheet conveying path R11 (an example of the conveying path of the present disclosure) including a conveying section by the conveying belt 41.

For example, the first conveyance processing portion 64 causes the operation display portion 6 to display a first guidance screen in response to a predetermined user operation on the operation display portion 6. The first guidance screen includes a message for urging the user to place a rectangular sheet on the sheet feed cassette 11. Further, the first guidance screen includes a first execution key used for an execution operation of the first conveyance process.

The first conveyance processing portion 64 executes the first conveyance process when a user operation on the first execution key is received. In the first conveyance process, the sheet placed on the sheet feed cassette 11 is conveyed along the sheet conveying path R11 using the sheet conveying portion 2 and the conveying unit 4.

The first acquisition processing portion 71 uses the line sensor 51 to execute a first acquisition process of acquiring the size in the conveying direction D11 of the sheet conveyed by the first conveyance processing portion 64 (see FIG. 2) and the size of the sheet in the width direction D12 (see FIG. 2) orthogonal to the conveying direction D11.

For example, the first acquisition processing portion 71 causes the shape reading portion 5 to start reading the shape of the sheet when the leading end of the sheet is detected by a sheet sensor (not shown) provided upstream of the line sensor 51 in the conveying direction D11 on the sheet conveying path R11 (see FIG. 1). Thus, the line data is output from the AFE circuit 52 at the imaging cycle. In addition, the first acquisition processing portion 71 terminates the reading of the shape of the sheet by the shape reading portion 5 when a predetermined specific time has elapsed from the time when the tailing end of the sheet was detected by the sheet sensor. The specific time is set so that the reading of the shape of the sheet by the shape reading portion 5 ends after the tailing end of the sheet has passed through the position facing the line sensor 51. Then, the first acquisition processing portion 71 acquires a plurality of line data items (shape data) output from the AFE circuit 52 during the period in which the shape of the sheet is read by the shape reading portion 5.

In addition, the first acquisition processing portion 71 counts the number of sheet pixels in the line data items that include sheet pixels indicating the presence of the sheet among the line data items included in the shape data. Then, the first acquisition processing portion 71 multiplies the count result by the size in the width direction D12 of the imaging elements included in the line sensor 51, thereby calculating the size in the width direction D12 of the sheet conveyed by the first conveyance processing portion 64.

In addition, the first acquisition processing portion 71 counts the number of the sheet pixels in a pixel row extending in a direction orthogonal to the extending direction of the line data items in the shape data (direction corresponding to the conveying direction D11). Then, the first acquisition processing portion 71 multiplies the count result by a conveying distance per imaging cycle by the conveying belt 41 to calculate the size in the conveying direction D11 of the sheet conveyed by the first conveyance processing portion 64. The conveying distance per imaging cycle by the conveying belt 41 is obtained by multiplying, by the imaging cycle, a design value of the conveying speed of the sheet by the conveying belt 41.

Here, the actual conveying distance per imaging cycle by the conveying belt 41 may be different from the design value due to individual error in the diameter of the first tension roller 42, wear of the first tension roller 42, and the like.

When the actual conveying distance per imaging cycle by the conveying belt 41 is faster than the design value, the image formed by the line heads 31 to 34 expands in the conveying direction D11 more than the original image. In addition, when the actual conveying distance per imaging cycle by the conveying belt 41 is faster than the design value, there are fewer opportunities for the line sensor 51 to capture an image of the sheet, so that the size of the sheet in the conveying direction D11 acquired by the first acquisition processing portion 71 is smaller than the actual size.

On the other hand, when the actual conveying distance per imaging cycle by the conveying belt 41 is slower than the design value, the image formed by the line heads 31 to 34 contracts in the conveying direction D11 more than the original image. In addition, when the actual conveying distance per imaging cycle by the conveying belt 41 is slower than the design value, there are more opportunities for the line sensor 51 to capture an image of the sheet, so that the size of the sheet in the conveying direction D11 acquired by the first acquisition processing portion 71 is larger than the actual size.

The second conveyance processing portion 65 executes a second conveyance process of conveying the sheet along the sheet conveying path R11 after the sheet is conveyed by the first conveyance processing portion 64.

For example, the second conveyance processing portion 65 causes the operation display portion 6 to display a second guidance screen after the sheet is conveyed by the first conveyance processing portion 64. The second guidance screen includes a message for urging the user to place the sheet discharged to the sheet discharge tray 12 (the sheet conveyed by the first conveyance processing portion 64) on the sheet feed cassette 11 in an orientation different from that when the sheet was conveyed by the first conveyance processing portion 64. In addition, the second guidance screen includes a second execution key used for an execution operation of the second conveyance process.

The second conveyance processing portion 65 executes the second conveyance process when a user operation on the second execution key is received. In the second conveyance process, the sheet placed on the sheet feed cassette 11 is conveyed along the sheet conveying path R11 using the sheet conveying portion 2 and the conveying unit 4.

Here, when the user acts in accordance with the message on the second guidance screen, the same sheet as the sheet conveyed by the first conveyance processing portion 64 is conveyed by the second conveyance processing portion 65 in an orientation different from that when the sheet was conveyed by the first conveyance processing portion 64. For example, an A4-size sheet conveyed in portrait orientation in the first conveyance process is conveyed in landscape orientation in the second conveyance process.

The second acquisition processing portion 72 uses the line sensor 51 to execute a second acquisition process of acquiring the size in the conveying direction D11 of the sheet conveyed by the second conveyance processing portion 65 (see FIG. 2) and the size of the sheet in the width direction D12 (see FIG. 2).

Specifically, the second acquisition processing portion 72 acquires the size in the conveying direction D11 and the size in the width direction D12 of the sheet conveyed by the second conveyance processing portion 65 using the same method as the first acquisition processing portion 71.

The determination processing portion 66 determines, based on the acquisition result of the first acquisition processing portion 71 and the acquisition result of the second acquisition processing portion 72, whether or not the same sheet as the sheet conveyed by the first conveyance processing portion 64 has been conveyed by the second conveyance processing portion 65 in an orientation different from that when the sheet was conveyed by the first conveyance processing portion 64.

For example, when the ratio of the size of the sheet in the conveying direction D11 acquired by the first acquisition processing portion 71 to the size of the sheet in the width direction D12 acquired by the second acquisition processing portion 72 falls within a predetermined allowable range and the ratio of the size of the sheet in the width direction D12 acquired by the first acquisition processing portion 71 to the size of the sheet in the conveying direction D11 acquired by the second acquisition processing portion 72 falls within the allowable range, the determination processing portion 66 determines that the same sheet as the sheet conveyed by the first conveyance processing portion 64 has been conveyed by the second conveyance processing portion 65 in an orientation different from that when the sheet was conveyed by the first conveyance processing portion 64. The allowable range is a range including “1”.

When it is determined that the same sheet as the sheet conveyed by the first conveyance processing portion 64 has been conveyed by the second conveyance processing portion 65 in an orientation different from that when the sheet was conveyed by the first conveyance processing portion 64, the expansion/contraction processing portion 67 expands or contracts the size of the image formed by the line heads 31 to 34 along the conveying direction D11 (see FIG. 2) based on the acquisition result of the first acquisition processing portion 71 and the acquisition result of the second acquisition processing portion 72.

For example, the expansion/contraction processing portion 67 expands or contracts the size of the image to be formed using the line heads 31 to 34 along the conveying direction D11 based on the larger one of the two sizes acquired by the first acquisition processing portion 71 and the larger one of the two sizes acquired by the second acquisition processing portion 72.

For example, the expansion/contraction processing portion 67 changes the ink ejection cycle of the line heads 31 to 34.

For example, when the sheet was conveyed in the portrait orientation in the first conveyance process and the sheet was conveyed in the landscape orientation in the second conveyance process, the expansion/contraction processing portion 67 acquires, as a correction value, a result obtained by dividing the size of the sheet in the conveying direction D11 acquired by the first acquisition processing portion 71 by the size of the sheet in the width direction D12 acquired by the second acquisition processing portion 72.

In addition, when the sheet was conveyed in the landscape orientation in the first conveyance process and the sheet was conveyed in the portrait orientation in the second conveyance process, the expansion/contraction processing portion 67 acquires, as the correction value, a result obtained by dividing the size of the sheet in the conveying direction D11 acquired by the second acquisition processing portion 72 by the size of the sheet in the width direction D12 acquired by the first acquisition processing portion 71.

Then, the expansion/contraction processing portion 67 multiplies the ejection cycle by the acquired correction value to change the ejection cycle.

The correction value is smaller than “1” when the actual conveying distance per imaging cycle by the conveying belt 41 is faster than the design value. In this case, the ejection cycle is shortened.

The correction value is larger than “1” when the actual conveying distance per imaging cycle by the conveying belt 41 is slower than the design value. In this case, the ejection cycle is extended.

For example, the expansion/contraction processing portion 67 changes the imaging cycle together with the ejection cycle. Specifically, the expansion/contraction processing portion 67 multiplies the imaging cycle by the acquired correction value to change the imaging cycle.

It is noted that the expansion/contraction processing portion 67 may expand or contract the size of the image to be formed by the line heads 31 to 34 along the conveying direction D11 by changing the conveying speed of the sheet by the conveying belt 41.

In addition, the expansion/contraction processing portion 67 may expand or contract the size of the image formed using the line heads 31 to 34 along the conveying direction D11 based on the smaller one of the two sizes acquired by the first acquisition processing portion 71 and the smaller one of the two sizes acquired by the second acquisition processing portion 72.

### [Image Quality Adjustment Processing]

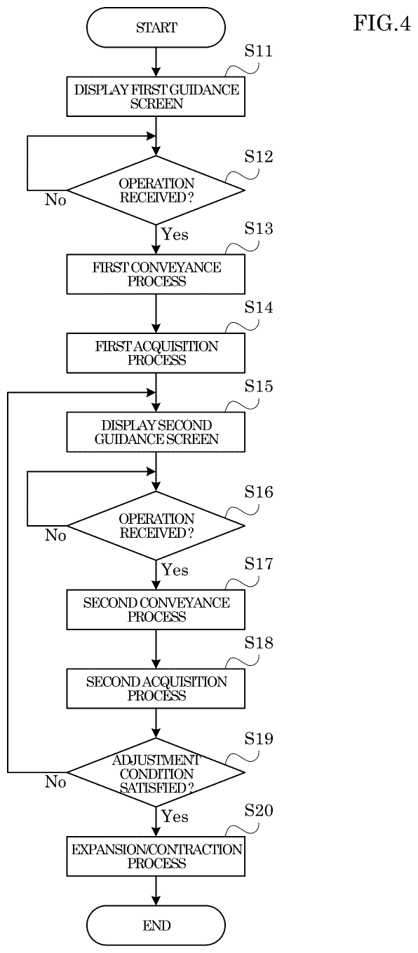

An image quality adjustment method according to the present disclosure will be described below with reference to FIG. 4, along with an example of the procedure of the image quality adjustment processing executed by the control portion 7 and the image processing portion 8 in the image forming apparatus 100. Here, steps S11, S12, . . . represent the numbers of the processing procedure (steps) executed by the control portion 7 or the image processing portion 8. It is noted that the image quality adjustment process is executed when a user operation instructing the execution of the image quality adjustment processing is received on the operation display portion 6.

### <Step S11>

In step S11, the control portion 7 causes the operation display portion 6 to display the first guidance screen. The process of step S11 is executed by the first conveyance processing portion 64 of the control portion 7.

### <Step S12>

In step S12, the control portion 7 determines whether or not a user operation on the first execution key included in the first guidance screen has been received.

Here, when it is determined that a user operation on the first execution key has been received (Yes in S12), the control portion 7 shifts the processing to step S13. When a user operation on the first execution key has not been received (No side of S12), the control portion 7 waits for a user operation on the first execution key in step S12.

### <Step S13>

In step S13, the control portion 7 executes the first conveyance process. The process of step S13 is an example of the first conveyance step of the present disclosure, and is executed by the first conveyance processing portion 64 of the control portion 7.

### <Step S14>

In step S14, the image processing portion 8 executes the first acquisition process. The process of step S14 is an example of the first acquisition step of the present disclosure, and is executed by the first acquisition processing portion 71 of the image processing portion 8.

### <Step S15>

In step S15, the control portion 7 causes the operation display portion 6 to display the second guidance screen. The process of step S15 is executed by the second conveyance processing portion 65 of the control portion 7.

### <Step S16>

In step S16, the control portion 7 determines whether or not a user operation on the second execution key included in the second guidance screen has been received.

Here, when it is determined that a user operation on the second execution key has been received (Yes in S16), the control portion 7 shifts the processing to step S17. In addition, when a user operation on the second execution key has not been received (No in S16), the control portion 7 waits for a user operation on the second execution key in step S16.

### <Step S17>

In step S17, the control portion 7 executes the second conveyance process. The process of step S17 is an example of the second conveyance step of the present disclosure, and is executed by the second conveyance processing portion 65 of the control portion 7.

<Step S18>

In step S18, the image processing portion 8 executes the second acquisition process. The process of step S18 is an example of the second acquisition step of the present disclosure, and is executed by the second acquisition processing portion 72 of the image processing portion 8.

### <Step S19>

In step S19, the control portion 7 determines whether or not the adjustment condition is satisfied.

Specifically, the control portion 7 determines that the adjustment condition is satisfied when the ratio of the size in the conveying direction D11 of the sheet acquired in the first acquisition process and the size in the width direction D12 of the sheet acquired in the second acquisition process falls within the allowable range and the ratio of the size in the width direction D12 of the sheet acquired in the first acquisition process and the size in the conveying direction D11 of the sheet acquired in the second acquisition process falls within the allowable range. Here, the process of determining whether or not the adjustment condition is satisfied is an example of the determination step of the present disclosure, and is executed by the determination processing portion 66 of the control portion 7.

Here, when it is determined that the adjustment condition is satisfied (Yes in S19), the control portion 7 shifts the processing to step S20. In addition, when the adjustment condition is not satisfied (No in S19), the control portion 7 shifts the processing to step S15. In this case, the control portion 7 may cause the operation display portion 6 to display a message to the effect that the same sheet as the sheet conveyed in the first conveyance process is not conveyed in the second conveyance process in an orientation different from that at the time of conveyance by the first conveyance process.

### <Step S20>

In step S20, the control portion 7 changes the ejection cycle of ink by the line heads 31 to 34 based on the acquisition result in the first acquisition process and the acquisition result in the second acquisition process. The process of step S20 is an example of the expansion/contraction step of the present disclosure, and is executed by the expansion/contraction processing portion 67 of the control portion 7.

Here, the control portion 7 changes the imaging cycle together with the ejection cycle. Thus, the image quality adjustment processing can be repeatedly executed. Therefore, it is possible to adjust the ejection cycle in accordance with a change in the conveying distance per imaging cycle by the conveying belt 41.

It is noted that the control portion 7 may receive manual setting operations of the ejection cycle and the imaging cycle outside the execution period of the image quality adjustment processing. The control portion 7 may then change the ejection cycle and the imaging cycle in accordance with the manual setting operations. Thus, a user who is not satisfied with the result of execution of the image quality adjustment processing can manually adjust the ejection cycle and the imaging cycle.

As described above, in the image forming apparatus 100, when it is determined that the same sheet as the sheet conveyed by the first conveyance processing portion 64 has been conveyed by the second conveyance processing portion 65 in an orientation different from that at the time of conveyance by the first conveyance processing portion 64, the ejection cycle of the ink by the line heads 31 to 34 is adjusted based on the acquisition result by the first acquisition processing portion 71 and the acquisition result by the second acquisition processing portion 72. That is, the image forming apparatus 100 can suppress expansion or contraction in the conveying direction D11 of an image to be formed without consuming ink.

### APPENDIXES OF INVENTION

The following are appendixes to the overview of the invention extracted from the above embodiment. It is noted that the structures and processing functions to be described in the following appendixes can be selected and combined arbitrarily.

### APPENDIX 1

An image forming apparatus comprising: a conveying belt configured to convey a sheet along a predetermined conveying direction; an ejection portion configured to eject ink onto the sheet conveyed by the conveying belt; an imaging portion configured to image the sheet conveyed by the conveying belt; a first conveyance processing portion configured to convey the sheet along a conveying path including a conveying section by the conveying belt; a first acquisition processing portion configured to use the imaging portion to acquire a size in the conveying direction of the sheet conveyed by the first conveyance processing portion and a size of the sheet in a width direction orthogonal to the conveying direction; a second conveyance processing portion configured to convey the sheet along the conveying path after the conveyance of the sheet by the first conveyance processing portion; a second acquisition processing portion configured to use the imaging portion to acquire a size in the conveying direction of the sheet conveyed by the second conveyance processing portion and a size in the width direction of the sheet; a determination processing portion configured to determine, based on an acquisition result of the first acquisition processing portion and an acquisition result of the second acquisition processing portion, whether or not a same sheet as the sheet conveyed by the first conveyance processing portion has been conveyed by the second conveyance processing portion in an orientation different from that when the sheet was conveyed by the first conveyance processing portion; and an expansion/contraction processing portion configured to expand or contract a size along the conveying direction of an image to be formed by the ejection portion based on the acquisition result of the first acquisition processing portion and the acquisition result of the second acquisition processing portion when it is determined that the same sheet as the sheet conveyed by the first conveyance processing portion has been conveyed by the second conveyance processing portion in the orientation different from that when the sheet was conveyed by the first conveyance processing portion.

### APPENDIX 2

The image forming apparatus according to Appendix 1, wherein the expansion/contraction processing portion changes an ejection cycle of the ink by the ejection portion.

### APPENDIX 3

The image forming apparatus according to Appendix 1 or 2, wherein the expansion/contraction processing portion expands or contracts the size along the conveying direction of the image to be formed using the ejection portion based on larger one of the two sizes acquired by the first acquisition processing portion and larger one of the two sizes acquired by the second acquisition processing portion.

### APPENDIX 4

An image quality adjustment method executed by an image forming apparatus including: a conveying belt configured to convey a sheet along a predetermined conveying direction; an ejection portion configured to eject ink onto the sheet conveyed by the conveying belt; and an imaging portion configured to image the sheet conveyed by the conveying belt, wherein a first conveyance step for conveying the sheet along a conveying path including a conveying section by the conveying belt; a first acquisition step for using the imaging portion to acquire a size in the conveying direction of the sheet conveyed in the first conveyance step and a size of the sheet in a width direction orthogonal to the conveying direction; a second conveyance step for conveying the sheet along the conveying path after the conveyance of the sheet in the first conveyance step; a second acquisition step for using the imaging portion to acquire a size in the conveying direction of the sheet conveyed in the second conveyance step and a size in the width direction of the sheet; a determination step for determining, based on an acquisition result of the first acquisition step and an acquisition result of the second acquisition step, whether or not a same sheet as the sheet conveyed in the first conveyance step has been conveyed by the second conveyance step in an orientation different from that when the sheet was conveyed by the first conveyance step; and an expansion/contraction step for expanding or contracting a size along the conveying direction of an image to be formed using the ejection portion based on the acquisition result of the first acquisition step and the acquisition result of the second acquisition step when it is determined that a same sheet as the sheet conveyed by the first conveyance step has been conveyed in the second conveyance step in an orientation different from that when the sheet was conveyed in the first conveyance step.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming apparatus comprising:
a conveying belt configured to convey a sheet along a predetermined conveying direction;
an ejection portion configured to eject ink onto the sheet conveyed by the conveying belt;
an imaging portion configured to image the sheet conveyed by the conveying belt;
a first conveyance processing portion configured to convey the sheet along a conveying path including a conveying section by the conveying belt;
a first acquisition processing portion configured to use the imaging portion to acquire a size in the conveying direction of the sheet conveyed by the first conveyance processing portion and a size of the sheet in a width direction orthogonal to the conveying direction;
a second conveyance processing portion configured to convey the sheet along the conveying path after the conveyance of the sheet by the first conveyance processing portion;
a second acquisition processing portion configured to use the imaging portion to acquire a size in the conveying direction of the sheet conveyed by the second conveyance processing portion and a size in the width direction of the sheet;
a determination processing portion configured to determine, based on an acquisition result of the first acquisition processing portion and an acquisition result of the second acquisition processing portion, whether or not a same sheet as the sheet conveyed by the first conveyance processing portion has been conveyed by the second conveyance processing portion in an orientation different from that when the sheet was conveyed by the first conveyance processing portion; and
an expansion/contraction processing portion configured to expand or contract a size along the conveying direction of an image to be formed by the ejection portion based on the acquisition result of the first acquisition processing portion and the acquisition result of the second acquisition processing portion when it is determined that the same sheet as the sheet conveyed by the first conveyance processing portion has been conveyed by the second conveyance processing portion in the orientation different from that when the sheet was conveyed by the first conveyance processing portion.

2. The image forming apparatus according to claim 1, wherein
the expansion/contraction processing portion changes an ejection cycle of the ink by the ejection portion.

3. The image forming apparatus according to claim 1, wherein
the expansion/contraction processing portion expands or contracts the size along the conveying direction of the image to be formed using the ejection portion based on larger one of the two sizes acquired by the first acquisition processing portion and larger one of the two sizes acquired by the second acquisition processing portion.

4. An image quality adjustment method executed by an image forming apparatus including a conveying belt configured to convey a sheet along a predetermined conveying direction, an ejection portion configured to eject ink onto the sheet conveyed by the conveying belt, and an imaging portion configured to image the sheet conveyed by the conveying belt, wherein
a first conveyance step for conveying the sheet along a conveying path including a conveying section by the conveying belt;
a first acquisition step for using the imaging portion to acquire a size in the conveying direction of the sheet conveyed by the first conveyance step and a size of the sheet in a width direction orthogonal to the conveying direction;
a second conveyance step for conveying the sheet along the conveying path after the conveyance of the sheet in the first conveyance step;
a second acquisition step for using the imaging portion to acquire a size in the conveying direction of the sheet conveyed in the second conveyance step and a size in the width direction of the sheet;
a determination step for determining, based on an acquisition result of the first acquisition step and an acquisition result of the second acquisition step, whether or not a same sheet as the sheet conveyed in the first conveyance step has been conveyed in the second conveyance step in an orientation different from that when the sheet was conveyed in the first conveyance step; and
an expansion/contraction step for expanding or contracting a size along the conveying direction of an image to be formed using the ejection portion based on the acquisition result of the first acquisition step and the acquisition result of the second acquisition step when it is determined that a same sheet as the sheet conveyed in the first conveyance step has been conveyed in the second conveyance step in an orientation different from that when the sheet was conveyed in the first conveyance step.
